(19) United States
(12) Patent Application Publication
(10) Pub. No.: US 2016/0267139 A1
(43) Pub. Date: Sep. 15, 2016

(54) KNOWLEDGE BASED SERVICE SYSTEM, SERVER FOR PROVIDING KNOWLEDGE BASED SERVICE, METHOD FOR KNOWLEDGE BASED SERVICE, AND NON-TRANSITORY COMPUTER READABLE RECORDING MEDIUM

(71) Applicant: SAMSUNG ELECTRONICS CO., LTD., Suwon-si (KR)

(72) Inventors: Kyung-duk KIM, Suwon-si (KR); Hyung-jong NOH, Suwon-si (KR); Eun-sang BAK, Jeju-si (KR); Geun-bae LEE, Seoul (KR); Sang-do HAN, Gunpo-si (KR)

(73) Assignee: SAMSUNG ELECTRONICS CO., LTD., Suwon-si (KR)

(21) Appl. No.: 15/065,044

(22) Filed: Mar. 9, 2016

(30) Foreign Application Priority Data
Mar. 10, 2015 (KR) 10-2015-0033436

(51) Int. Cl. G06F 17/30; G06N 5/02

(52) U.S. Cl. CPC G06F 17/30477; G06F 17/30554; G06N 5/02

(57) ABSTRACT

A knowledge-based service system, a knowledge-based service server, a method for providing a knowledge-based service, and a non-transitory computer-readable recording medium thereof, are provided. The knowledge-based service system includes a display apparatus configured to receive a query from a user, and a knowledge-based service server configured to receive the query from the display apparatus, determine whether a word that is included in the received query is at least one among an entity and an attribute, and transmit, to the display apparatus, an answer to the query based on a result of the determination.

### CROSS-REFERENCE TO RELATED APPLICATION

This application claims priority from Korean Patent Application No. 10-2015-0033436, filed on Mar. 10, 2015, in the Korean Intellectual Property Office, the disclosure of which is incorporated herein by reference in its entirety.

### BACKGROUND

1. Field

Apparatuses and methods consistent with exemplary embodiments relate to a knowledge-based service system, a knowledge-based service server, a method for providing the knowledge-based service, and a non-transitory computer readable recording medium thereof.

2. Description of the Related Art

There are many types of sentences made of natural words that make queries regarding attributes of a subject, for example, “When is Mr. Kim*Ah's birthday?” or “What is the height of 63 Building?” These are sentences asking the attribute, ‘birthday’, of the subject, ‘Mr. Kim*Ah’, and the attribute, ‘height’, of the subject, ‘63 Building’. If it is possible to properly extract the subject and attribute from such a sentence, it is possible to answer the query for ‘birthday’ of ‘Mr. Kim*Ah’ after searching the ‘birthday’ of ‘Mr. Kim*Ah’ from a database (DB) consisting of names of people and birthdays, and likewise, it is possible to answer the query for ‘height’ of ‘63 Building’ after searching a height field of 63 Building from a DB consisting of buildings and their heights.

However, such a conventional method is a field search method, wherein a word corresponding to the subject has to be searched from a two-dimensional search table of a lattice format, and then a word of attribute has to be searched as well. Thus, it takes a lot of time for searching to find an answer.

### SUMMARY

Exemplary embodiments address at least the above problems and/or disadvantages and other disadvantages not described above. Also, the exemplary embodiments are not required to overcome the disadvantages described above, and may not overcome any of the problems described above.

One or more exemplary embodiments provide, when a user provides a query to be answered through for example a television (TV) or smart phone, a knowledge-based service system that provides an answer based on attributes of words of the query, for example a result of determining a relevance, a server for providing a knowledge-based service, a method for the knowledge-based service, and a computer readable recording medium thereof.

According to an aspect of an exemplary embodiment, there is provided a knowledge-based service system including a display apparatus configured to receive a query from a user, and a knowledge-based service server configured to receive the query from the display apparatus, determine whether a word that is included in the received query is at least one among an entity and an attribute, and transmit, to the display apparatus, an answer to the query based on a result of the determination.

According to an aspect of another exemplary embodiment, there is provided a knowledge-based service server including a storage configured to store an answer to a query of a user, a communication interface configured to receive the query, and a knowledge-based information processor configured to determine whether a word that is included in the received query is at least one among an entity and an attribute, and output the stored answer based on a result of the determination.

The knowledge-based information processor may include a word extractor configured to extract the word from the received query, and a word combiner configured to, based on the result of the determination whether the extracted word is at least one among the entity and the attribute, combine a word of entity and a word of attribute. The knowledge-based information processor may be further configured to output the answer matching with the combined words.

The word extractor may be further configured to, in response to the received query being a sentence, extract the word using at least one among a dependency structure analysis method of extracting a word that has a dependent relationship with a predicate, a meaning structure analysis method of analyzing a meaning of each word in a sentence, and a method of extracting a word after identifying a part of speech of the word.

The storage may be further configured to store the word of entity that is related to the entity and the word of attribute that is related to the attribute, and the knowledge-based information processor may be further configured to output the answer matching with the word of entity and the word of attribute that are obtained separately from the word included in the query.

The storage may be further configured to store words of entity having different meanings and a same spelling, and the knowledge-based information processor may be further configured to select the word of entity having been linked at least a number of times from the words of entity.

The storage may be further configured to store words of attribute using an interpretation vector method of expressing a word in a vector format, and the knowledge-based information processor may be further configured to select, from the words of attribute, a word of which a vector distance from the word included in the query is smallest as the word of attribute.

The word included in the query may be of a different language from the word of entity and the word of attribute.

The knowledge-based information processor may be further configured to determine whether a first word that is included in the query is the word of entity, and in response to the knowledge-based processor determining that the first word is the word of entity, automatically determine that a second word included in the query is the word of attribute.

According to an aspect of another exemplary embodiment, there is provided a method for providing a knowledge-based service, the method including receiving a query of a user, determining whether a word that is included in the received query is at least one among an entity and an attribute, and outputting an answer based on a result of the determining.

The method may further include extracting the word from the received query, and based on a result of the determining whether the extracted word is at least one among the entity and the attribute, combining a word of entity and a word of attribute. The outputting may include outputting the answer matching with the combined words.

The extracting may include, in response to the received query being a sentence, extracting the word using at least one among a dependency structure analysis method of extracting a word that has a dependent relationship with a predicate, a meaning structure analysis method of analyzing a meaning of each word in a sentence, and a method of extracting a word after identifying a part of speech of the word.

The method may further include storing the word of entity that is related to the entity and the word of attribute that is related to the attribute, and the outputting may include outputting the answer matching with the word of entity and the word of attribute that are obtained separately from the word of the query.

The method may further include storing words of entity having different meanings and a same spelling, and the outputting may include selecting the word of entity having been linked at least a number of times from the words of entity.

The method may further include storing words of attribute using an interpretation vector method of expressing a word in a vector format, and the outputting may include selecting, from the words of attribute, a word of which a vector distance from the word included in the query is smallest as the word of attribute.

The determining may include determining whether a first word that is included in the query is the word of entity, and in response to the determining that the first word is the word of entity, automatically determining that a second word included in the query is the word of attribute.

A non-transitory computer-readable recording medium may include a program to cause a computer to execute the method.

### BRIEF DESCRIPTION OF THE DRAWINGS

The above and/or other aspects will be more apparent by describing exemplary embodiments with reference to the accompanying drawings, in which

FIG. 1 is a view illustrating a knowledge-based service system according to an exemplary embodiment;

FIG. 2 is a view illustrating a detailed structure of an apparatus for providing a knowledge-based service of FIG. 1;

FIG. 3 is a view illustrating another detailed structure of the apparatus for providing the knowledge-based service of FIG. 1;

FIG. 4 is a view for explaining a method for expressing words in interpretation vectors;

FIG. 5 is a view illustrating a detailed structure of a knowledge-based information processor of FIG. 2;

FIG. 6 is a view illustrating another detailed structure of the knowledge-based information processor of FIG. 2; and

FIG. 7 is a flowchart illustrating a method for providing a knowledge-based service according to an exemplary embodiment.

### DETAILED DESCRIPTION OF EXEMPLARY EMBODIMENTS

Exemplary embodiments are described in greater detail below with reference to the accompanying drawings

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions may not be described in detail because they would obscure the description with unnecessary detail.

It will be understood that the terms “comprises” and/or “comprising” used herein specify the presence of stated features or components, but do not preclude the presence or addition of one or more other features or components. In addition, the terms such as “unit”, “-er (-or)”, and “module” described in the specification refer to an element for performing at least one function or operation, and may be implemented in hardware, software, or the combination of hardware and software.

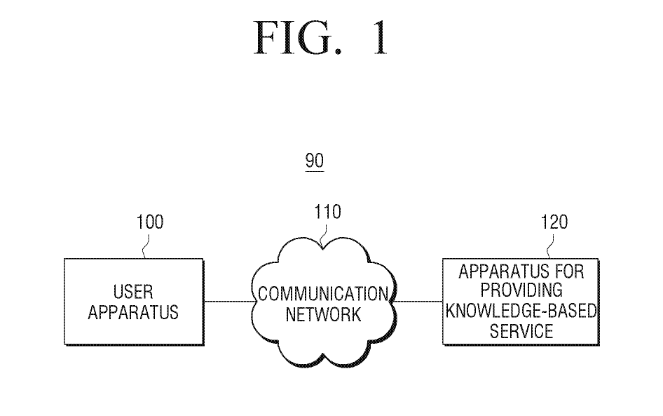

FIG. 1 is a view illustrating a knowledge-based service system 90 according to an exemplary embodiment.

As illustrated in FIG. 1, the knowledge-based service system 90 according to an exemplary embodiment may include an entirety or a portion of a user apparatus 100 (or display apparatus), a communication network 110, and an apparatus for providing a knowledge-based service 120 (or a server for the knowledge-based service).

Herein, including an entirety or a portion of the aforementioned means that some of the components such as the communication network 110 may be omitted, and thus the user apparatus 100 and the apparatus for providing a knowledge-based service 120 may perform a direct (e.g., peer-to-peer (P2P)) communication. However, for sufficient understanding of the present disclosure, explanation will be made based on an assumption that all the aforementioned components are included.

The user apparatus 100 may include a display apparatus such as for example, a digital television (DTV), smart phone, desktop computer, laptop computer, tablet personal computer (PC), a wearable apparatus, and the like that are capable of providing search functions. The user apparatus 100 receives a text or voice query through a search window or microphone from a user who requests for an answer to the query, and allows the received query to be provided to the apparatus for providing a knowledge-based service 120 via the communication network 110. Herein, the user apparatus 100 may provide a text based recognition result to the apparatus for providing a knowledge-based service 120. For example, in the case of receiving a voice as a query, the user apparatus 100 may receive a voice query through a voice receiver such as a microphone, recognize the received voice query using a speech engine such as *-Voice, that is, a program, and output a result of recognition in a text based format.

However, because the apparatus for providing a knowledge-based service 120 may have a far more excellent engine, that is, a program, than the user apparatus 100, the text may be created based on a result of recognition in the apparatus for providing a knowledge-based service 120. In other words, the user apparatus 100 transmits only the voice signals received through the microphone, and the apparatus for providing a knowledge-based service 120 creates the text based result of recognition and voice recognition based on the received voice signals. Therefore, the result of recognition may be processed in one or more ways.

According to an exemplary embodiment, the user apparatus 100 may receive queries of various formats from the user. Herein, queries of various formats may mean words or sentences, and queries of various formats may mean receiving one word, receiving a plurality of words, or receiving in a sentence format. Herein, a word may consist of only words corresponding to an entity defined in an exemplary embodiment (hereinafter referred to as ‘words of names of entities’), or of only words corresponding to attributes (hereinafter referred to as ‘words of attributes’). Otherwise, the word may be a combination of a word of entity name and a word of attribute. A sentence may also include words of various attributes, and there may be a difference that the words form a complete sentence when compared to a case of a plurality of words. This will be explained in more detail hereinafter, but it may be apparent by searching a word extracted from a query in a knowledge-based database (DB).

Any word, for example ‘Oh*ma’ may be a name of entity or attribute. This may be determined based on how the system designer constructed the knowledge-based DB. In other words, if ‘Oh*ma’ is included in the entity name DB, it is a word of entity name, whereas if ‘Oh*ma’ is included in the attribute DB, it is a word of attribute. As such, a knowledge-based DB includes numerous DB s that are connected to one another (like a mesh) and operate, and has increased search efficiency compared to a DB. When numerous words of attribute are associated to one word of identity, and then each of those words of attribute become a word of identity, new words of attribute may again be associated to that word of identify. Based on the aforementioned, in an exemplary embodiment, DBs may be classified into a DB for words of entity, a DB for words of attribute, and a DB for the words of entity and words of attribute that are combined with each other. Further DBs may be included, for example a DB for words of entity combined with words of entity, and a DB for words of attribute combined with words of attribute.

For example, when a user makes a query for “US president”, ‘Oh*ma’ may be an attribute because it belongs to the “US president”. On the other hand, when a user makes a query for ‘Oh*ma’, various things related to ‘Oh*ma’ may be associated as attributes. For example, the attributes may include birthday, home town, age, school and the like. This depends on how the DB is constructed. Therefore, when the user makes a query of “Oh*ma birthday”, the user apparatus 100 may first determine the characteristics of the two words, that is, relevance of the two words. In other words, the user apparatus 100 determines whether both words are words of entity, words of attribute, or whether one is a word of entity and the other is a word of attribute. If it is determined that, for example, ‘Oh*ma’ is a word of entity, and ‘birthday’ is a word of attribute, the word of entity, ‘Oh*ma’, and the word of attribute, ‘birthday’, may be combined with each other, and then the user apparatus 100 may receive an answer to the combined words. That is, an answer extracted through an additional DB for combined words may be provided to the user apparatus 100. In this process, in an exemplary embodiment, when a DB for words of entity or a DB for words of attribute is constructed based on another language, a new word of entity and a word of attribute of that different language may be extracted from the DB, the extracted words may be combined with each other, and then an answer matching the combined words may be received. As aforementioned, a user may be provided with answers of various formats depending on the characteristics of the word from the user's query, that is, the relevance, for example, the word of entity and word of attribute, and depending on the method how the DB was constructed. Herein, providing for example, ‘BarakO**ma’ that has the closest meaning to the Korean-based word ‘ [symbol] ’ (meaning Ohbama in Korean) from a DB constructed in an interpretation vector method may be a good example of providing a new word of a different language.

Examples of the communication network 110 include both wired and wireless communication networks. Herein, examples of a wired network includes an internet network such as a cable network and public telephone network (PSTN), and examples of a wireless communication network includes code division multiple access (CDMA), wideband code division multiple access (WCDMA), Global System for Mobile Communications (GSM), Evolved Packet Core (EPC), Long Term Evolution (LTE), and Wireless Broadband (WiBro) network. However, the communication network 110 according to an exemplary embodiment is not limited to the aforementioned. The communication network 110 is an access network of a next generation mobile communication system, for example, one that may be used in cloud computing networks under a cloud computing environment. For example, when the communication network 110 is a wired communication network, an access point within the communication network 110 may access an exchange station of a telephone office. However, when the communication network 110 is a wireless communication network, a serving general packet radio service (GPRS) support node (SGSN) or a gateway GPRS support node (GGSN) that is operated by communication companies is accessed to process data, or various relay stations such as a base transceiver station (BTS), NodeB, and eNodeB is accessed to process data.

The communication network 110 may include an access point. The access point includes a small base station such as a femto or pico base station widely installed in buildings. Herein, differentiation between a femto and a pico base station is made depending on how many units of user apparatuses 100 may be accessed. Examples of an access point include a short distance communication module for performing short distance communication such as Zigbee and Wi-Fi with the user apparatus 100. The access point may use a Transmission Control Protocol (TCP)/Internet Protocol (IP) or Real-Time Streaming Protocol (RTSP) for wireless communication. Herein, the short-distance communication may be performed in various standards such as radio frequency (RF) and ultra wide band (UWB) including Bluetooth, Zigbee, Infrared Data Association (IrDA), ultra high frequency (UHF) and very high frequency (VHF). Accordingly, the access point may extract a location of a data packet, designate an optimal communication path to the extracted location, and transmit the data packet to the next apparatus, for example, to the user apparatus 100 via the designated communication path. Access points may share numerous lines in a network environment, and may include for example, a router, repeater and relay and the like.

The apparatus for providing a knowledge-based service 120 includes a server, and may either include a knowledge-based DB (KDB) or operate in association with a separate DB (hereinafter referred to as operating in an interlocked manner). Based on such a knowledge-based DB, the apparatus for providing a knowledge-based service 120 provides an answer to the query made by the user. For this purpose, the apparatus for providing a knowledge-based service 120 determines whether a word(s) included in a user's query received is at least one of a word of entity and a word of attribute. In other words, in an exemplary embodiment, the apparatus for providing a knowledge-based service 120 determines a word of entity and a word of attribute based on a DB for words of entity and a DB for words of attribute that operate in an interlocked manner, the two DB s disposed physically distanced from each other, based on a knowledge-based DB method, combines the determined word of entity with the word of attribute, and then provides an answer matching the combined two words. In an exemplary embodiment, there is no limitation to the DB for words of entity and the DB for words of attribute being physically distanced from each other.

The apparatus for providing a knowledge-based service 120 may first differentiate between a word of entity and a word of attribute from the words of the query received. For example, assuming that the apparatus for providing a knowledge-based service 120 received a question that reads ‘Where is the home town of Oh*ma?’, the apparatus for providing a knowledge-based service 120 may extract two words: ‘Oh*ma’ and ‘home town’, and then search the DB for words of entity and the DB for words of attribute to differentiate between the word of entity and the word of attribute. By doing this, the apparatus for providing a knowledge-based service 120 determines whether each of the words in the query is a word of entity or of attribute. Then, the apparatus for providing a knowledge-based service 120 finds an answer that matches the combined word consisting of the word of entity and the word of attribute from the DB for the combined words. A word of attribute may also become a word of entity as aforementioned, and thus if the word of attribute and word of entity are combined in the order of word of attribute +word of entity, the result may be a completely different answer. Thus, in an exemplary embodiment, such combining of words may be a factor.

If a request to determine which of ‘Oh*ma’ and ‘home town’ is a word of entity and a word of attribute, is received, it is easy to know that ‘home town’ is an attribute of the entity ‘Oh*ma’. However, the apparatus for providing a knowledge-based service 120 does not know this until it searches each DB. That is because, there may be a case in which both words are words of entity, and a case in which both words are words of attribute, for example. Therefore, a completely different result may be provided to the user depending on the result of determination. In this regard, the apparatus for providing a knowledge-based service 120 may first search the DB for words of entity for ‘Oh*ma’ and determine that ‘Oh*ma’ is a word of entity, and then automatically determine that ‘home town’ is a word of attribute based on learning. However, unless ‘home town’ is determined as a word of entity based on a DB, it is desirable to further search the DB for words of attribute. For example, for some time, the apparatus for providing a knowledge-based service 120 may search each DB for ‘Oh*ma’ and ‘home town’ to determine whether they are a word of entity or a word of attribute, and then when a same query is input again later on, the apparatus for providing a knowledge-based service 120 may automatically determine that ‘home town’ is a word of attribute based on the experience until then. This is learning. For example, if the user makes a query reading “When were TVs developed?”, words of ‘TV’, ‘when’, and ‘developed’ is extracted. However, because ‘when’ may be excluded from being a word of entity nor a word of attribute, a search in the knowledge-based DB may be used for ‘when’.

In this process, the apparatus for providing a knowledge-based service 120 may obtain a word of entity and a word of attribute expressed in a different language, combine these words with the word extracted as mentioned earlier, and provide the combined word as an answer. In other words, in a case of searching the DB for words of entity for the Korean word ‘ [symbol] ’, if there is no corresponding word, a word having the same meaning is extracted. For this purpose, the knowledge-based DB extracts words stored in a method of expressing words in interpretation vector. For example, ‘BarakO***ma’ may be extracted. Furthermore, regarding ‘birthday’, the DB for words of attributes may be searched to extract a word that reads ‘birthdate’. Then, two extracted words may be combined, and an answer matching the combined word may be provided.

An answer being provided to the user may differ significantly depending on which method the knowledge-based DB was constructed. For example, in a case of constructing words based on Wikipedia documents, an operation may be made in the aforementioned format. On the other hand, in a case in which a Korean-based DB is constructed, a determination may be made whether a word from a user's query is a word of entity or a word of attribute, i.e., whether the word is at least one of a word of entity and a word of attribute, and then a search may be made in different knowledge-based DB s according to a result of the determining. In other words, in another exemplary embodiment, the knowledge-based DB may be a search DB of combined words consisting of a word of entity and a word of entity, a search DB of combined words consisting of a word of attribute and a word of attribute, and/or a search DB of combined words consisting of a word of entity and a word of attribute, and thus an answer may be provided in various formats.

By constructing such a knowledge-based DB, and using the constructed DB to combine a core word from the user's query, that is, a word of entity, with a knowledge-based attribute to provide an answer to the query, it is possible to maximize the efficiency of answering the query. That is, it is possible to provide information suitable to the user's intentions. For example, if a combination is made with an inappropriate attribute or a combination is not made properly, a completely different answer is provided or an answer may not be provided at all, but an exemplary embodiment is conducive to resolving such a problem.

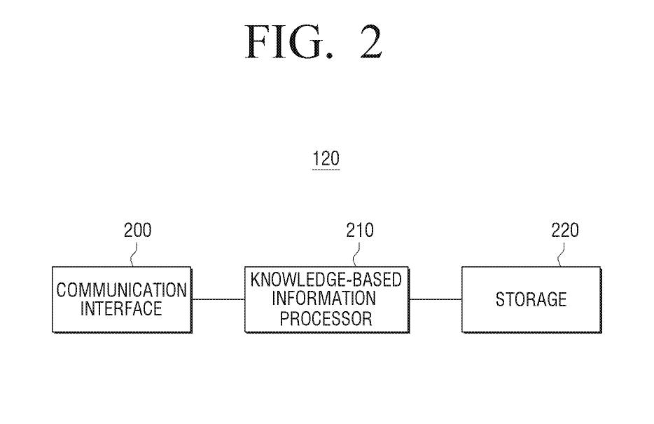

FIG. 2 is a view illustrating a detailed structure of the apparatus for providing a knowledge-based service 120 of FIG. 1. In FIG. 2, it is illustrated that the apparatus for providing a knowledge-based service is configured as being divided in terms of hardware.

Referring to FIG. 2 along with FIG. 1 for convenience of explanation, the apparatus for providing a knowledge-based service 120 according to an exemplary embodiment may include an entirety or portion of a communication interface 200, a knowledge-based information processor 210, and storage 220.

Herein, to include an entirety or a portion of the components means that some of the components such as the communication interface 200 may be omitted, or some of the components such as the storage 220 may be integrated into another component such as the knowledge-based information processor 210. However, for sufficient understanding of the present disclosure, explanation will be made based on an assumption that an entirety of the components aforementioned are included.

The communication interface 200 receives a user's query from the user apparatus 100. Herein, the received query may be a text-based recognition result, but in response to the received query being a voice signal, a recognition result may be created having recognizing the voice signal in a text-based format. Otherwise, the communication interface 200 may provide a voice signal to the knowledge-based information processor 210 to allow the knowledge-based information processor 210 to create a recognition result. Moreover, the communication interface 200 may receive an answer to the user's query received from the knowledge-based information processor 210, and transmit the answer to the user apparatus 100.

The knowledge-based information processor 210 may determine the characteristics of the word(s) included in the user's query received. For example, the knowledge-based information processor 210 may determine the relevance of a word, that is, whether the word is a word of entity or a word of attribute. For example, a case in which there is a query that reads “Oh*ma” may be compared with a case in which there is a query that reads “When is Oh*ma's birthday?”. When there is a query that reads “Oh*ma”, the knowledge-based information processor 210 may determine whether the word is a word of entity or a word of attribute. For this purpose, the knowledge-based information processor 210 may search the DB for words of entity and the DB for words of attribute, and provide an answer from the DB that has a matching to ‘Oh*ma’. On the other hand, when there is a query that reads “When is Oh*ma's birthday?”, the words ‘Oh*ma’, ‘birthday’, and ‘when’ are extracted. Herein, the extracted words may be differentiated into a word of entity and a word of attribute, but in this process, a part of speech of the words may be additionally determined, and accordingly ‘when’ may be excluded. Then, determination is made whether the two words: ‘Oh*ma’ and ‘birthday’ are words of entity or words of attribute. Then, when it is determined that ‘Oh*ma’ is a word of entity, and ‘birthday’ is a word of attribute by searching DB, these words are combined in the order of word of entity+word of attribute again. In this process, because combining the words in the order of word of attribute+word of entity may provide a completely different answer, the order of combining the words may be a factor. A same answer or a completely different answer may be provided depending on the DB construction method, and thus there is no limitation thereto. Furthermore, the knowledge-based information processor 210 searches the DB for combined words to find an answer matching the combined word, and extracts the answer and provides it to the user. For this purpose, the knowledge-based information processor 210 may operate in an interlocked manner with the storage 220.

Physically and in terms of software, the storage 220 may be differentiated into a storage area for words of entity, a storage area for words of attribute, and a storage area for combined words. As such, the knowledge-based information processor 210 may approach different areas of the storage 220 and derive a desired result. That is, the storage 220 may output a result that matches, for example, a combined word at a request from the knowledge-based information processor 210.

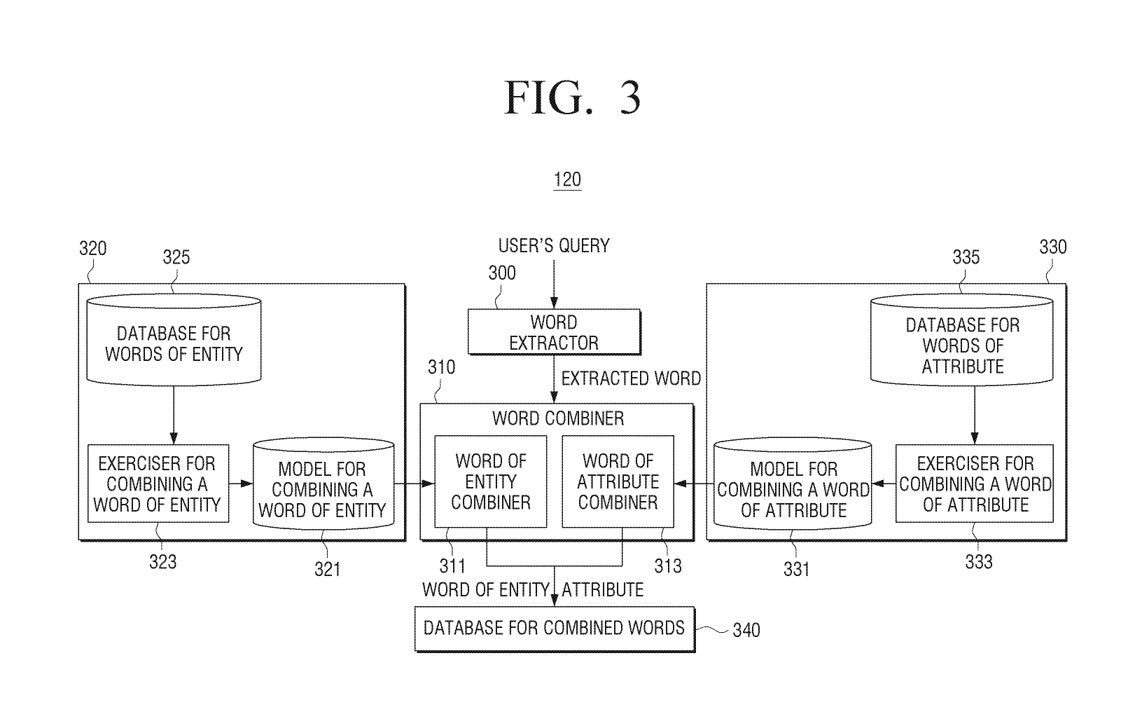

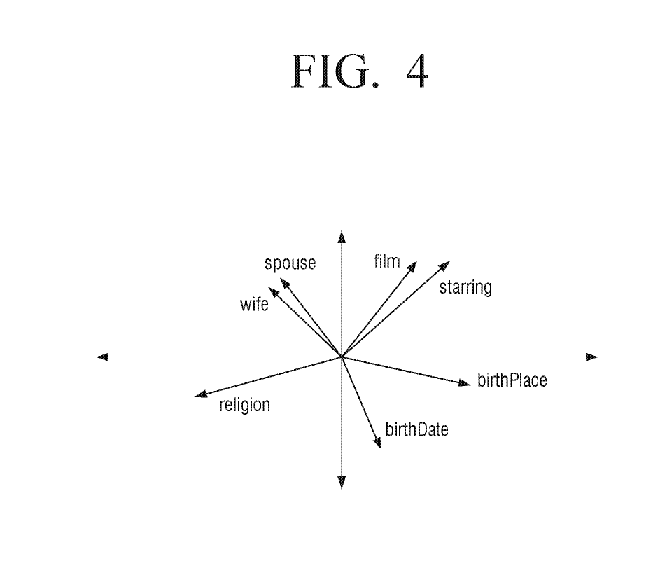

FIG. 3 is a view illustrating another detailed structure of the apparatus for providing the knowledge-based service 120 of FIG. 1, the apparatus being configured in terms of software by way of example. FIG. 4 is a view for explaining a method for expressing words in interpretation vectors.

Referring to FIG. 3 along with FIG. 1 for convenience of explanation, the apparatus for providing a knowledge-based service 120 according to another exemplary embodiment of the present disclosure includes a word extractor 300 (i.e., a word extraction module), a word combiner 310 (i.e., a word combination module), a DB for words of entity 320, a DB for words of attribute 330, and a DB for combined words 340.

For convenience of explanation, explanation on a case in which one word is provided will be omitted. In other words, when one word is received as a user's query, the word extractor 300 may provide the word to the word combiner 310 without an additional process of extracting a word. Then, each of a word of entity combiner 311 (i.e., a module for combination of words of entity) and a word of attribute combiner 313 (i.e., a module for combination of words of attribute) searches each DB and determine whether the word is a word of entity or a word of attribute. Furthermore, according to a result of determination, each of the word of entity combiner 311 and the word of attribute combiner 313 searches the DB for combined words 340, and provide a matching answer.

Assuming a case in which a plurality of words are received as a user's query, the word extractor 300 is for extracting, from the user's query, words that could be used in data search. The word extractor 300 extracts words to be combined from a sentence input by the user, and the extracted words are then combined with an appropriate word of entity and a word of attribute in each DB. In other words, the word extractor 300 is configured to extract from the user's query words to be combined with attributes. If the user's input has a word format, the word may be combined as it is, but if the user input a query in a natural language format, words to be combined are extracted. In this case, words that have a dependent relationship with a predicate may be extracted through a dependent structure analysis, or core words may be extracted using a method of analyzing the relationships with proper nouns in the sentence. Furthermore, there is also a method of checking the part of speech of the words to extract a word that is a verb, and a word that is a noun and the like. These methods may be combined and then used to extract words as well. Besides these, there are other various methods that can be used for extracting core information from a sentence.

To identify a dependency relationship, the word extractor 300 may include a syntax analyzer configured to analyze dependency relationships. One of the criteria for classifying syntax analyzers is the grammar used. The syntax analyzer performs its function according to a grammar. However, these grammars have their unique characteristics, and carefully selecting the grammar to be applied based on the characteristics of languages may a first step in syntax analysis. Grammars that are mainly applied to syntax analysis include phrase-structure grammar, categorical grammar, and dependency grammar.

Whether the method used is an automatic method based on learning or a passive method by a person may also be a criterion for classifying syntax analyzers when constructing grammars for syntax analysis. The automatic method based on learning uses a large volume syntax analysis corpus that has been refined, and includes even grammar rules having relatively low probability, and thus tends to have a large number of rules. The method wherein a user directly makes rules may take a lot of time and involve much knowledge on Korean grammar.

Korean syntax analyzers may be classified according to the basic unit of syntax analysis. That is because in English, one word usually consists of one morpheme, and therefore there is no big difference. However, in Korean, one word usually consists of one or more morphemes. Therefore, Korean syntax analyzers may be classified depending on whether the basic unit is a morpheme, or word. The language for which syntax analysis by machines has developed the most is English.

Furthermore, the word extractor 300 may analyze what roles each word plays in the sentence using the meaning structure analysis method, and extract words using the result of analysis. Verbs, agents, and patients that are core information in a sentence may be used.

Furthermore, the word extractor 300 may extract a word using a method for checking the part of speech. The word extractor 300 may divide the word input by the user in units of morphemes, and then automatically extract the part of speech of each morpheme. It may also analyze verbs, nouns and proper nouns that exist in the sentence, and extract the corresponding core words.

The word combiner 310 is configured to combine the extracted word with an appropriate word of entity or attribute. The word combiner 310 includes the word of entity combiner 311 and the word of attribute combiner 313. The word of entity combiner 311 is for combining a word to be combined with a word of entity with an appropriate word of entity. The word of attribute combiner 313 is for combining an extracted word with an appropriate attribute in the knowledge-based DB.

The word combiner 310 combines each extracted word with an appropriate word of entity and with an appropriate attribute. Herein, the word combiner 310 identifies whether to combine the word with a word of entity or with an attribute. This may be done by combining the word both to the word of entity combiner 311 and the word of attribute combiner 313, then finding all the appropriate words of entity and attributes, then measuring the reliability in the combining process, and then performing a combination only when the reliability is above a level.

The word of entity combiner 311 is configured to match a user's keyword that has been input to an appropriate word of entity in a database. For example, when the user made a query of a format of “Where is the home town of Mr. Kim* Ah?” or “Mr. Kim*Ah, home town”, the word extractor 300 extracts ‘Mr. Kim*Ah’ and ‘home town’, and the word of entity combiner 311 combines the word ‘Mr. Kim*Ah’ with a word of entity, kim-**a in the knowledge-based DB. In the case of ‘home town’, a combination is not made unless there is an appropriate word of entity, and when there is a word of entity such as, home town, that word of entity is also combined and output. However, in such a case, the word of entity, kim_**a, and the word of entity, home town, are not connected in the knowledge-based DB, and thus no information is output that is not suitable to the query. The method in which the word of entity combiner 311 finds an appropriate word of entity and performs a combining process is performed based on a model for combining a word of entity. This will be explained in more detail later on.

The word of attribute combiner 313 is a configured to match a user's keyword that has been input to an appropriate attribute in terms of meaning. For example, when the user makes a query of “Where is the home town of Mr. Kim*Ah?” or “Mr. Kim*Ah, home town”, the word extractor 300 may extract ‘Mr. Kim*Ah’ and ‘home town’, and combine the word ‘home town’ with the most closest attribute in the knowledge-based DB in terms of meaning, that is, ‘birthPlace’. Because the word ‘Mr. Kim*Ah’ has no attribute with a reliability that is or above the appropriate reliability, it may not be combined. Such an attribute combination process is determined based on a model for combining a word of attribute 331. This will be explained in more detail later on.

The DB for words of entity 320 includes a model for combining a word of entity 321, an exerciser for combining a word of entity 323, and a DB for words of entity 325. The model for combining a word of entity 321 is used to combine an appropriate word of entity in the word of entity combiner 311. This model is a model exercised based on the DB for words of entity 325. The exerciser for combining a word of entity 323 exercises the model for combining a word of entity using a mechanical learning method or rule-based method based on the DB for words of entity 325. The DB for words of entity 325 is exercising data for exercising the model for combining a word of entity, and may include a knowledge-based DB that is based on Wikipedia or DBpedia.

The model for combining a word of entity 321 is a model for exercising using the exerciser for combining a word of entity 323 based on the DB for words of entity 325. The exerciser for combining a word of entity 323 creates the model for combining a word of entity 321 based on the DB for words of entity 325. The exerciser for combining a word of entity 323 is a model for combining an input word with an appropriate word of entity. It first finds an appropriate word of entity through word matching. For example, when the user inputs ‘O**ma’ or ‘*** cruise’ in English, it combines the input word with an appropriate word of entity through word matching of ‘barak_o**ma’, ‘***_cruise’ existing in Wikipedia. However, when ‘ [symbol] * [symbol] ’ or ‘* [symbol] ’, that are Korean words, is input, matching may be performed using phonetic transcriptions of the Korean words. However, in a case of a word such as ‘Kashmir’, there is a place called ‘Kashmir’ and also a song title called ‘Kashmir’. Thus, combinations may be made with numerous words of entity, and a combination may be made with the more famous word of entity. Determining whether or not a page is more famous is estimated based on the number of external links existing in the Wikipedia page of the word of entity. The more famous a page is, the more people have corrected it, and thus the popularity of the word of entity may be measured by the number of links in the Wikipedia page. In the aforementioned case, there are more links in the Wikipedia page for the place called ‘Kashmir’, and thus a combination is made with the place. The DB for words of entity 325 is exercise data for combining a word from a user's query with a word of entity in the knowledge-based DB. The DB for words of entity 325 includes a database having a sentence format such as a natural language DB (e.g., Wikipedia).

The DB for words of attribute 330 includes a model for combining a word of attribute 331, an exerciser for combining a word of attribute 333, and a DB for words of attribute 335. The model for combining a word of attribute 331 is a model used to combine with an appropriate attribute in the word of attribute combiner 313. This model is a model exercised based on the DB for words of attribute 335. The exerciser for combining a word of attribute 333 exercises the model for combining a word of attribute using a mechanical learning method of rule-based method based on the DB for words of attribute 335. The DB for words of attribute 335 is exercising data for exercising the model for combining a keyword attribute, and includes a DB that is used as the knowledge-based DB such as Wikipedia.

The model for combining a word of attribute 331 is a model exercised using the exerciser for combining a word of attribute 333 based on the DB for words of attribute. The exerciser for combining a word of attribute 333 creates the model for combining a word of attribute 331 based on the DB for words of attribute 335. The exerciser for combining a word of attribute 333 displays a meaning of an input word in a vector format. First of all, the meaning may be expressed in an interpretation vector format based on a DB of a sentence format. Herein, the interpretation vector refers to a method of expressing a word in a vector format, each vector expressing a meaning of the word. In FIG. 4, words are expressed in a vector format on a two-dimensional plane. In FIG. 4, ‘wife’ and ‘spouse’ that are words having similar meanings have similar vector formats, whereas ‘religion’ and ‘starring’ have different meanings and therefore are far apart in the vector format. When the user inputs the word ‘film’, this word is also expressed in a vector format, and is matched to the word ‘starring’ that is the closest in the vector. Such a method of expressing words in an interpretation vector format is illustrated in FIG. 4.

When each word is expressed in an interpretation vector, the dimension of each vector is for example, the documents of Wikipedia, and the value of each dimension may be determined by a tf/idf score between the document and input word. More detailed explanation is as shown in Table 1 and Table 2.

TABLE 1

| property | movie | birth | language | location | date | marry | . . . |
|---|---|---|---|---|---|---|---|
| starring | 7.15 | 0.1 | 0.01 | 0.1 | 0.01 | 0.1 | . . . |
| birthdate | 0.1 | 4.49 | 0.01 | 0.01 | 3.89 | 0.1 | . . . |
| birthdate | 0.1 | 5.01 | 0.01 | 2.3 | 0.01 | 0.1 | . . . |

TABLE 2

| Document | Word | TFIDF Score |
|---|---|---|
| Fruit | Apple | 4.28 |
| Fruit | Iron | 0.3 |
| Fruit | the | 0.12 |

Referring to Table 1, the leftmost column are words to be expressed in vectors, and the topmost line are documents of Wikipedia. For example, the value of ‘movie’ column for ‘starring’ line, that is, 7.15, represents a tf/idf value that the word ‘starring’ has with the Wikipedia document ‘movie’. Herein, the if/idf is a yardstick showing how much the word is important to the document. For example, referring to Table 2, ‘apple’ has a high tf/idf value because it is an important word in the document ‘fruit’, whereas words such as ‘iron’ and ‘the’ have low tf/idf values because they are not important words. These word vectors created in the aforementioned format is used to find the closest attribute through measurement of similarity between vectors, and to combine the words. However, if the similarity between the vectors is low, a combination is not made.

Secondly, if a sentence type DB and knowledge-based DB share the same information, models can be exercised in another method. For example, if there is knowledge-based data that reads, ‘Kim*Ah/birthplace/Korea’, and a sentence that reads ‘Mr. Kim*Ah is from Korea’ in the DB, because the two words of entity ‘Mr. Kim*Ah’ and ‘Korea’ exist in both the knowledge-based data and the DB, it can be seen that the attribute ‘birthplace’ has the same meaning as ‘from’. As such, it is possible to create a DB of a word-attribute matching format using both the data of triple format and data of sentence format, and utilize the same as a model in performing a combination. Regarding the above, a document “PATTY: A Taxonomy of Relational Patterns with Semantic Types” may be referred to.

Lastly, when a word of attribute in the knowledge-based DB is expressed in Latin, or expressed in a symbolic meaning, there may be limitations to the aforementioned exercising method. For example, the attribute ‘graduated school’ may be in Latin such as ‘almaMater’, or it may be expressed in a word only used in domains. Furthermore, if the word is insufficient in terms of the exercise data according to the aforementioned method, the performance may come out low. For this purpose, it is possible to add a word-attribute combination rule and improve the performance.

However, by applying the exercise method used in the exerciser for combining a word of attribute 333, it may be possible to create a DB such as a natural language templet used for outputting data extracted from the knowledge-based DB in a natural language format.

The DB for words of attribute 335 is exercise data for combining a word from a user's query with an attribute in the knowledge-based DB. Examples of the DB for words of attribute 335 include a sentence format DB such as a natural language DB (ex: Wikipedia) and a triple format DB (ex: DBpedia).

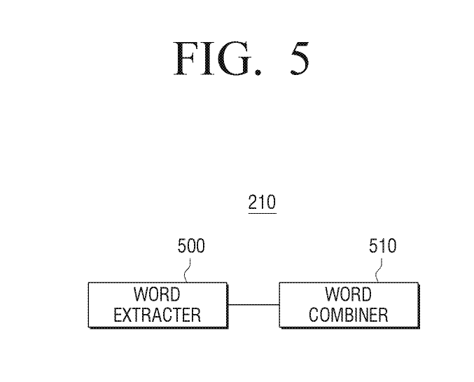

FIG. 5 is a view illustrating a detailed structure of the knowledge-based information processor 210 of FIG. 2.

Referring to FIG. 5 along with FIG. 2 for convenience of explanation, the knowledge-based information processor 210 according to an exemplary embodiment includes a word extractor 500 and a word combiner 510.

The word extractor 500 and word combiner 510 illustrated in FIG. 5 are not much different from the word extractor 300 and word combiner 310 of FIG. 3. However, the word extractor 500 and word combiner 510 of FIG. 5 may be physically separated from each other and may each include a program for performing their operations. For example, each program may be a program such as the word extractor 300 and word combiner 310 of FIG. 3, which performs the same operations as the word extractor 300 and word combiner 310 of FIG. 3.

Therefore, the same explanation on the word extractor 300 and word combiner 310 of FIG. 3 may apply to the word extractor 500 and word combiner 510 of FIG. 5.

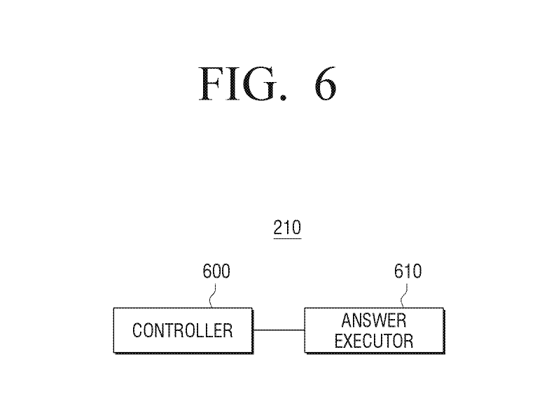

FIG. 6 is a view illustrating another detailed structure of the knowledge-based information processor 210 of FIG. 2.

As illustrated in FIG. 6, the knowledge-based information processor 210 according to another exemplary embodiment of the present disclosure includes a controller 600 and an answer executor 610.

The controller 600 may control the overall operations of the apparatus for providing a knowledge-based service illustrated in FIG. 1. For example, the controller 600 may include a CPU and an internal memory. Based on the aforementioned, when the apparatus for providing a knowledge-base service 120 initiates operation for example, the controller 600 may call a program stored in the answer executor 610, store the program in the internal memory, and then execute the program and operate accordingly. In other words, when a query is received from the user, the controller 600 may execute the program stored in the memory and perform the same operations as the word extractor 300 and word combiner 310 illustrated in FIG. 3. In this case, it can be seen that the answer executor 610 plays the role of a ROM or EPROM and EEPROM. Herein, EPROM is a readable memory device that may delete the program that has been provided at the time of release and perform a reprogramming. EEPROM is a memory device that deletes the stored contents with a high voltage, and thus belongs to the category of EPROM, but it is different from UVEPROM that deletes the stored contents with ultraviolet rays.

On the other hand, when the apparatus for providing a knowledge-based service 120 is starting its operation, if the controller 600 does not store the program stored in the answer executor 610 in a separate internal memory as aforementioned, when receiving a user's query, the controller 600 may obtain an answer to the query by operating the answer executor 610. In other words, the answer executor 610 operates according to a control by the controller 600, and for example, it may extract an answer to the query by executing an internal program and provide the answer to the controller 600. For this purpose, the answer executor 610 may perform the same operations as the word extractor 300 and word combiner 310 of FIG. 3.

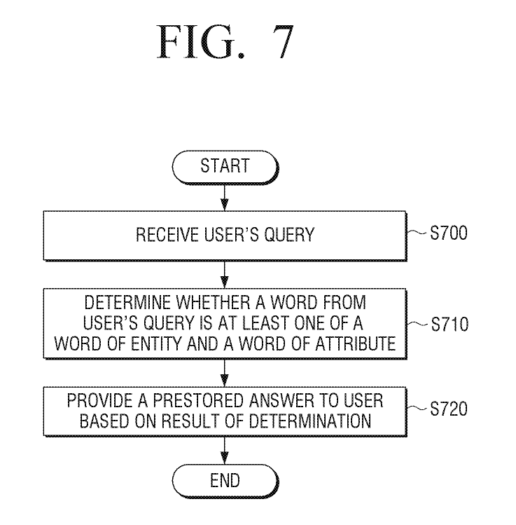

FIG. 7 is a flowchart illustrating a method for providing a knowledge-based service according to an exemplary embodiment.

Referring to FIG. 7 along with FIG. 1 for convenience of explanation, the apparatus for providing a knowledge-based service 120 according to an exemplary embodiment receives a user's query (S700). Herein, the user's query may receive a text-based recognition result.

Then, the apparatus for providing a knowledge-based service 120 may determine the relevance of the word(s) from the user's query, and as a result, for example, determines whether the word(s) from the user's query is at least one of a word of entity and a word of attribute (S710). In other words, the relevance may be analyzed as a characteristic of the word(s) from the user's query. For example, the user may provide a query of various formats as aforementioned. In a case of providing only word(s), one or more words may be provided, or a sentence may be provided. For example, the user may make a query such as ‘Oh*ma’ or ‘Oh*ma birthday’, or as a sentence such as ‘When is Oh*ma's birthday?’. Herein, one word may be a word of entity or a word of attribute, or a plurality of words may be a plurality of words of entity or a plurality of words of attribute.

Therefore, the apparatus for providing a knowledge-based service 120 may search the knowledge-based DB to determine at least one of the characteristics of the word(s) from the query, that is, whether the word is at least one of a word of entity and a word of attribute, or in the case of a plurality of words, determine the relevance. In other words, if the subject word is in the DB for words of entity, the apparatus for providing a knowledge-based service 120 may determine the subject word as a word of entity, and if the subject word is in the DB for words of attribute, the apparatus for providing a knowledge-based service 120 determines the subject word as a word of attribute. In this process, if there is no matching, the closest word may be extracted and provided. This was explained in full detail hereinabove, and thus further explanation will be omitted.

Furthermore, the apparatus for providing a knowledge-based service 120 provides or outputs a prestored answer to the user based on a result of the determination (S720). For example, if a word of entity and a word of attribute have been combined as a result of analyzing the user's query, an answer matching the combined word is provided by the apparatus for providing a knowledge-based service 120. Regarding this matter, it was fully explained hereinabove that an answer may be provided in various methods, and thus further explanation will be omitted.

In addition, the exemplary embodiments may also be implemented through computer-readable code and/or instructions on a medium, e.g., a computer-readable medium, to control at least one processing element to implement any above-described embodiments. The medium may correspond to any medium or media that may serve as a storage and/or perform transmission of the computer-readable code.

The computer-readable code may be recorded and/or transferred on a medium in a variety of ways, and examples of the medium include recording media, such as magnetic storage media (e.g., ROM, floppy disks, hard disks, etc.) and optical recording media (e.g., compact disc read only memories (CD-ROMs) or digital versatile discs (DVDs)), and transmission media such as Internet transmission media. Thus, the medium may have a structure suitable for storing or carrying a signal or information, such as a device carrying a bitstream according to one or more exemplary embodiments. The medium may also be on a distributed network, so that the computer-readable code is stored and/or transferred on the medium and executed in a distributed fashion. Furthermore, the processing element may include a processor or a computer processor, and the processing element may be distributed and/or included in a single device.

The foregoing exemplary embodiments are examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A knowledge-based service system comprising:
a display apparatus configured to receive a query from a user; and
a knowledge-based service server configured to:
receive the query from the display apparatus;
determine whether a word that is included in the received query is at least one among an entity and an attribute; and
transmit, to the display apparatus, an answer to the query based on a result of the determination.

2. A knowledge-based service server comprising:
a storage configured to store an answer to a query of a user;
a communication interface configured to receive the query; and
a knowledge-based information processor configured to:
determine whether a word that is included in the received query is at least one among an entity and an attribute; and
output the stored answer based on a result of the determination.

3. The knowledge-based service server of claim 2, wherein the knowledge-based information processor comprises:
a word extractor configured to extract the word from the received query; and
a word combiner configured to, based on the result of the determination whether the extracted word is at least one among the entity and the attribute, combine a word of entity and a word of attribute,
wherein the knowledge-based information processor is further configured to output the answer matching with the combined words.

4. The knowledge-based service server of claim 3, wherein the word extractor is further configured to, in response to the received query being a sentence, extract the word using at least one among a dependency structure analysis method of extracting a word that has a dependent relationship with a predicate, a meaning structure analysis method of analyzing a meaning of each word in a sentence, and a method of extracting a word after identifying a part of speech of the word.

5. The knowledge-based service server of claim 3, wherein the storage is further configured to store the word of entity that is related to the entity and the word of attribute that is related to the attribute, and
the knowledge-based information processor is further configured to output the answer matching with the word of entity and the word of attribute that are obtained separately from the word included in the query.

6. The knowledge-based service server of claim 3, wherein the storage is further configured to store words of entity having different meanings and a same spelling, and
the knowledge-based information processor is further configured to select the word of entity having been linked at least a number of times from the words of entity.

7. The knowledge-based service server of claim 3, wherein the storage is further configured to store words of attribute using an interpretation vector method of expressing a word in a vector format, and
the knowledge-based information processor is further configured to select, from the words of attribute, a word of which a vector distance from the word included in the query is smallest as the word of attribute.

8. The knowledge-based service server of claim 3, wherein the word included in the query is of a different language from the word of entity and the word of attribute.

9. The server of claim 3, wherein the knowledge-based information processor is further configured to:
determine whether a first word that is included in the query is the word of entity; and
in response to the knowledge-based processor determining that the first word is the word of entity, automatically determine that a second word included in the query is the word of attribute.

10. A method for providing a knowledge-based service, the method comprising:
receiving a query of a user;
determining whether a word that is included in the received query is at least one among an entity and an attribute; and
outputting an answer based on a result of the determining.

11. The method of claim 10, further comprising:
extracting the word from the received query; and
based on a result of the determining whether the extracted word is at least one among the entity and the attribute, combining a word of entity and a word of attribute,
wherein the outputting comprises outputting the answer matching with the combined words.

12. The method of claim 11, wherein the extracting comprises, in response to the received query being a sentence, extracting the word using at least one among a dependency structure analysis method of extracting a word that has a dependent relationship with a predicate, a meaning structure analysis method of analyzing a meaning of each word in a sentence, and a method of extracting a word after identifying a part of speech of the word.

13. The method of claim 11, further comprising storing the word of entity that is related to the entity and the word of attribute that is related to the attribute,
wherein the outputting comprises outputting the answer matching with the word of entity and the word of attribute that are obtained separately from the word of the query.

14. The method of claim 11, further comprising storing words of entity having different meanings and a same spelling,
wherein the outputting comprises selecting the word of entity having been linked at least a number of times from the words of entity.

15. The method of claim 11, further comprising storing words of attribute using an interpretation vector method of expressing a word in a vector format,
wherein the outputting comprises selecting, from the words of attribute, a word of which a vector distance from the word included in the query is smallest as the word of attribute.

16. The method of claim 11, wherein the word included in the query is of a different language from the word of entity and the word of attribute.

17. The method of claim 11, wherein the determining comprises:
determining whether a first word that is included in the query is the word of entity; and
in response to the determining that the first word is the word of entity, automatically determining that a second word included in the query is the word of attribute.

18. A non-transitory computer-readable recording medium comprising a program to cause a computer to execute the method of claim 11.
